(19) United States
(12) Patent Application Publication
(10) Pub. No.: US 2013/0154958 A1
(43) Pub. Date: Jun. 20, 2013

(54) CONTENT SYSTEM WITH SECONDARY TOUCH CONTROLLER

(71) Applicants: John Clavin, Seattle, WA (US); Kenneth A. Lobb, Sammamish, WA (US); Christopher M. Novak, Redmond, WA (US); Kevin Geisner, Mercer Island, WA (US); Christian Klein, Duvall, WA (US)

(72) Inventors: John Clavin, Seattle, WA (US); Kenneth A. Lobb, Sammamish, WA (US); Christopher M. Novak, Redmond, WA (US); Kevin Geisner, Mercer Island, WA (US); Christian Klein, Duvall, WA (US)

(73) Assignee: MICROSOFT CORPORATION, Redmond, WA (US)

(21) Appl. No.: 13/331,726

(22) Filed: Dec. 20, 2011

(51) Int. Cl. G06F 3/041

(52) U.S. Cl. 345/173

(57) ABSTRACT

A controller for a content presentation and interaction system which includes a primary content presentation device. The controller includes a tactile control input and a touch screen control input. The tactile control input is responsive to the inputs of a first user and communicatively coupled to the content presentation device. The controller a plurality of tactile input mechanisms and provides a first set of the plurality of control inputs manipulating content. The controller includes a touch screen control input responsive to the inputs of the first user and communicatively coupled to the content presentation device. The second controller is proximate the first controller and provides a second set of the plurality of control inputs. The second set of control inputs includes alternative inputs for at least some of the controls and additional inputs not available using the tactile input mechanisms.

### BACKGROUND

Users of content services have a number of options for controlling the content presentation device. The television remote control has become ever more complicated and has the ability to control multiple devices. Game controllers used with game playing platforms not only allow users to participate in playing games, but also allow user to consume content provided on the gaming devices.

New control options have been provided through so-called “smart” or tablet computing devices having touch screens. For example, content providers allow users to install an application on a user's smart phone which will stream content from a remote source (such as Netflix) or even change the channels on one's television (using the XfinityTV application from Comcast). While these different control options are useful in certain embodiments, tactile devices are preferred in other cases.

### SUMMARY

Technology is provided which allows a user to have a secondary media or control experience on a touch enabled controller when consuming passive or participatory content using a primary processing system and primary tactile controller. The secondary experience is provided in a controller for a content presentation and interaction system which includes a primary content presentation device. The controller includes a tactile control input and a touch screen control input. The tactile control input is responsive to the inputs of a first user and communicatively coupled to the content presentation device. The controller a plurality of tactile input mechanisms and provides a first set of the plurality of control inputs manipulating content. The controller includes a touch screen control input responsive to the inputs of the first user and communicatively coupled to the content presentation device. The second controller is proximate the first controller and provides a second set of the plurality of control inputs. The second set of control inputs includes alternative inputs for at least some of the controls and additional inputs not available using the tactile input mechanisms.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 depicts an exemplary gaming and media system.

FIG. 2 depicts an exemplary use case for the present technology.

FIG. 3 depicts a block diagram of an overview of components for implementing the present technology.

FIG. 4 is a block diagram of an exemplary system for implementing the present technology.

FIG. 5 is a flow chart illustrating an example of the present technology.

FIGS. 6A-10C are plan and side views of various embodiments for integrating a tactile controller with a touch screen interface controller.

FIGS. 11-16 are depictions of various embodiments of primary content and secondary environments provided on the touch screen interface controllers discussed herein.

FIG. 17 is a flow chart illustrating various interfaces which may be provided.

FIG. 18 is a block diagram of an exemplary processing device.

FIG. 19 is a block diagram of an exemplary touch screen interface device.

FIG. 20 is a block diagram of an exemplary console device.

### DETAILED DESCRIPTION

Technology is provided which allows a user to have a secondary media or control experience on a touch enabled controller when consuming passive or participatory content using a primary processing system and primary tactile controller. A secondary controller can be provided using an integrated, connected or communicating processing device which adapts a secondary interface to the content being consumed. One aspect includes providing a secondary controller for a gaming experience or streaming media. An entertainment service provides content and tracks a user's online activities. Based on content selected by the user for consumption in an entertainment system, the service determines a proper secondary experience for a touch screen interface and provides the experience in conjunction with the content. Content may be provided form third party sources as well, in which case a processing device or console may provide feedback on the nature of the content to the entertainment service

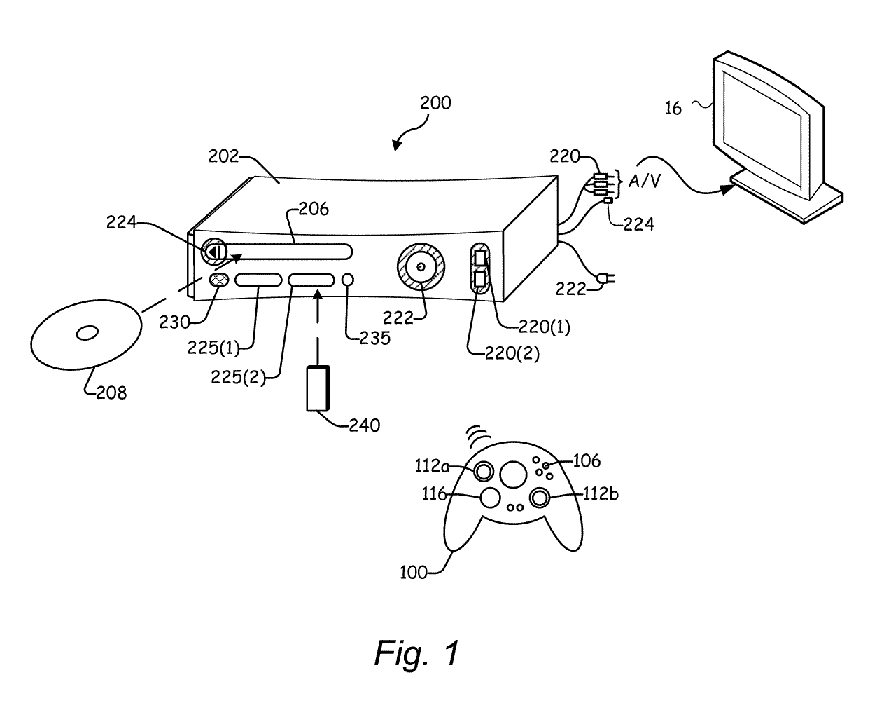

The technology may be utilized in conjunction with a primary processing device as illustrated in FIGS. 1, 18 and 20. FIG. 1 shows exemplary gaming and media system. As shown in FIG. 1, gaming and media system 200 includes a game and media console (hereinafter “console”) 202. In general, console 202 is one type of computing system, as will be further described below. Console 202 is configured to accommodate one or more wireless controllers, as represented by controllers 204(1) and 204(2). Console 202 is equipped with an internal hard disk drive (not shown) and a portable media drive 206 that support various forms of portable storage media, as represented by optical storage disc 208. Examples of suitable portable storage media include DVD, CD-ROM, game discs, and so forth. Console 202 also includes two memory unit card receptacles 225(1) and 225(2), for receiving removable flash-type memory units 240. A command button 235 on console 202 enables and disables wireless peripheral support.

Console 202 also includes an optical port 230 for communicating wirelessly with one or more devices and two USB (Universal Serial Bus) ports 210(1) and 210(2) to support a wired connection for additional controllers, or other peripherals. In some implementations, the number and arrangement of additional ports may be modified. A power button 212 and an eject button 214 are also positioned on the front face of game console 202. Power button 212 is selected to apply power to the game console, and can also provide access to other features and controls, and eject button 214 alternately opens and closes the tray of a portable media drive 206 to enable insertion and extraction of a storage disc 208.

Console 202 connects to a television or other display (such as monitor 250) via NV interfacing cables 220. In one implementation, console 202 is equipped with a dedicated NV port (not shown) configured for content-secured digital communication using NV cables 220 (e.g., NV cables suitable for coupling to a High Definition Multimedia Interface “HDMI” port on a high definition display 16 or other display device). A power cable 222 provides power to the game console. Console 202 may be further configured with broadband capabilities, as represented by a cable or modem connector 224 to facilitate access to a network, such as the Internet. The broadband capabilities can also be provided wirelessly, through a broadband network such as a wireless fidelity (Wi-Fi) network.

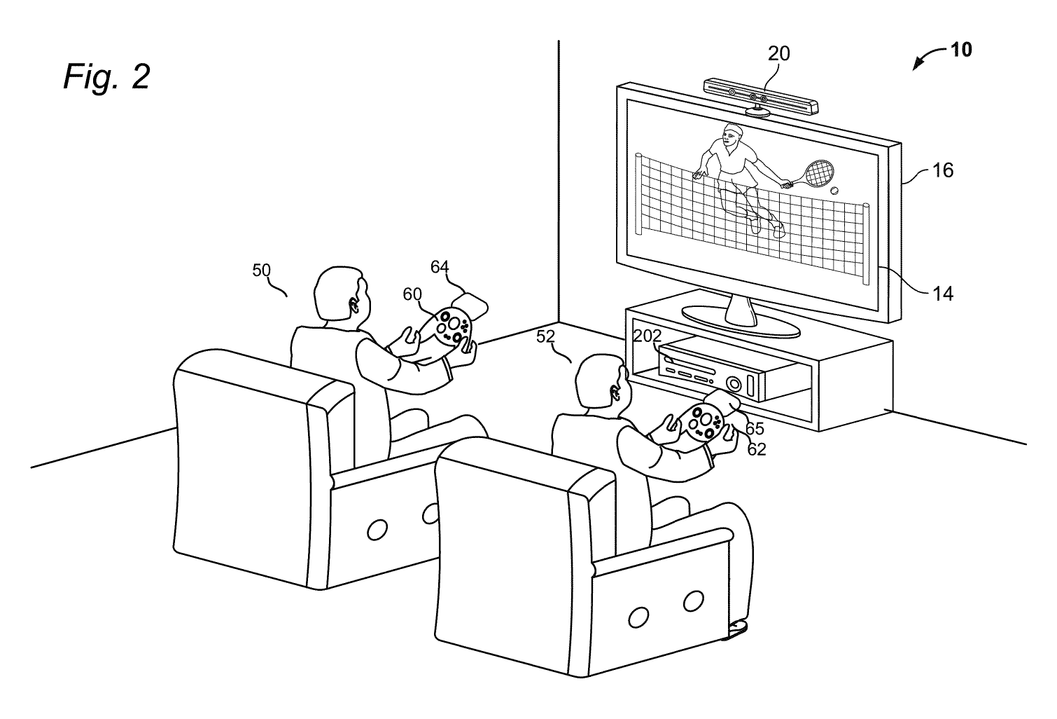

Each controller 100 is coupled to console 202 via a wired or wireless interface. In the illustrated implementation, the controller 100 is coupled to console 202 via a wireless connection. Console 202 may be equipped with any of a wide variety of user interaction mechanisms. In an example illustrated in FIG. 2, each controller 100 is equipped with two thumbsticks 112(a) and 112(b), a D-pad 116, buttons 106, and two triggers 110.

These controllers 100 are merely representative, and additional embodiments of controller 100 are discussed herein. Because several common elements exist between the various controllers, they are generally commonly numbered 100, which variations as applicable noted herein.

In one implementation, a memory unit (MU) 240 may also be inserted into controller 204 to provide additional and portable storage. Portable MUs enable users to store game parameters for use when playing on other consoles. In this implementation, each controller is configured to accommodate two MUs 240, although more or less than two MUs may also be employed.

Gaming and media system 200 is generally configured for playing games stored on a memory medium, as well as for downloading and playing games, and reproducing pre-recorded music and videos, from both electronic and hard media sources. With the different storage offerings, titles can be played from the hard disk drive, from an optical disk media (e.g., 208), from an online source, or from MU 240. A sample of the types of media that gaming and media system 200 is capable of playing include:
Game titles played from CD and DVD discs, from the hard disk drive, or from an online source.
Digital music played from a CD in portable media drive 206, from a file on the hard disk drive (e.g., music in the Windows Media Audio (WMA) format), or from online streaming sources.
Digital audio/video played from a DVD disc in portable media drive 206, from a file on the hard disk drive (e.g., Active Streaming Format), or from online streaming sources.
   During operation, console 202 is configured to receive input from controllers 100 and display information on display 16. For example, console 202 can display a user interface on display 250 to allow a user to select a game using controller 100 and display

FIG. 2 illustrates a common user scenario which may be employed using the technology described herein. In accordance with the present technology, a touch display controller is utilized in conjunction with the tactile controller to provide a secondary experience along with the content 14 provided by the entertainment system 200.

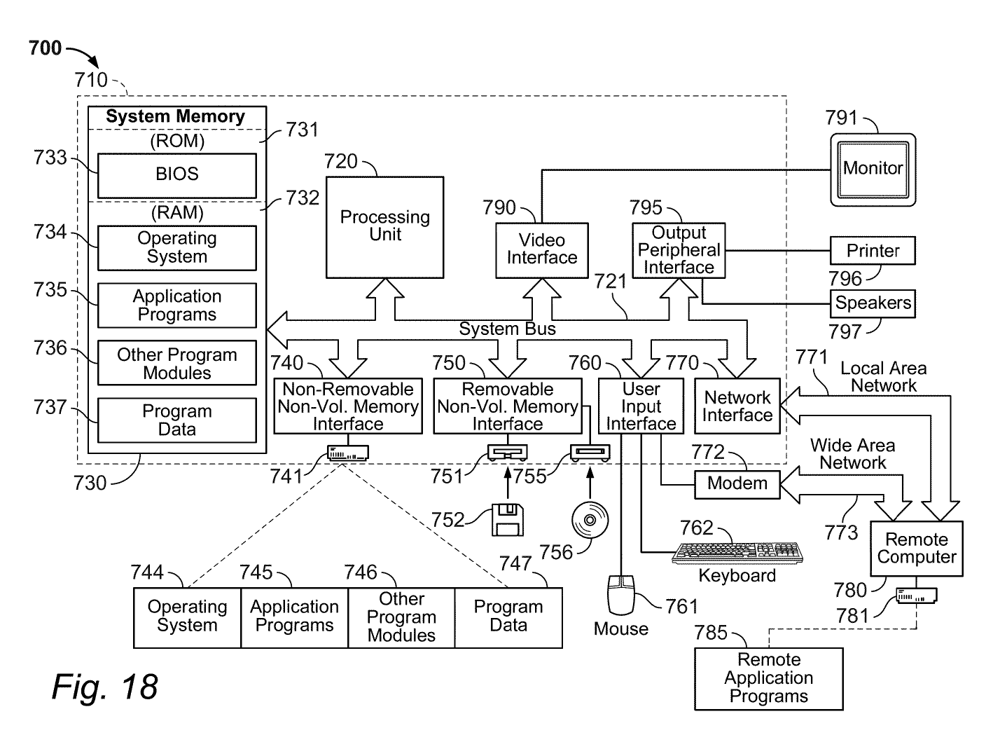

In FIG. 2, two users 50 and 52 are shown seated in front of a display device 16 on which a piece of shared content 14, in this case a tennis match, is displayed. Each user, 50, 52 has an associated processing controller 60, 62. Each controller 60, 62 has a respective associated touch component 64, 65. In FIG. 2, the controllers are illustrated as integrated with touch devices, but the controllers 60. 62 may comprise any of the various controllers discussed herein. Also shown in FIG. 2 is an entertainment system 200 which may comprise a gaming console 202, the display device 16, and a capture device 20, all discussed below with respect to FIGS. 18 through 20.

FIG. 2 also illustrates a second controller comprising a target recognition and tracking device 20. The target recognition and tracking device 20 may comprise system such as the Microsoft Kinect® controller, various embodiments of which are described in the following co-pending patent applications, all of which are hereby specifically incorporated by reference: U.S. patent application Ser. No. 12/475,094, entitled “Environment and/or Target Segmentation,” filed May 29, 2009; U.S. patent application Ser. No. 12/511,850, entitled “Auto Generating a Visual Representation,” filed Jul. 29, 2009; U.S. patent application Ser. No. 12/474,655, entitled “Gesture Tool,” filed May 29, 2009; U.S. patent application Ser. No. 12/603,437, entitled “Pose Tracking Pipeline,” filed Oct. 21, 2009; U.S. patent application Ser. No. 12/475,308, entitled “Device for Identifying and Tracking Multiple Humans Over Time,” filed May 29, 2009, U.S. patent application Ser. No. 12/575,388, entitled “Human Tracking System,” filed Oct. 7, 2009; U.S. patent application Ser. No. 12/422,661, entitled “Gesture Recognizer System Architecture,” filed Apr. 13, 2009; and U.S. patent application Ser. No. 12/391,150, entitled “Standard Gestures,” filed Feb. 23, 2009.

As illustrated in FIG. 2, each user has their own controller which is equipped with a touch sensitive component 64, 65. The touch sensitive component is used in conjunction with the main controller 60 and 62 in order to provide a secondary media control experience on a touch enable controller.

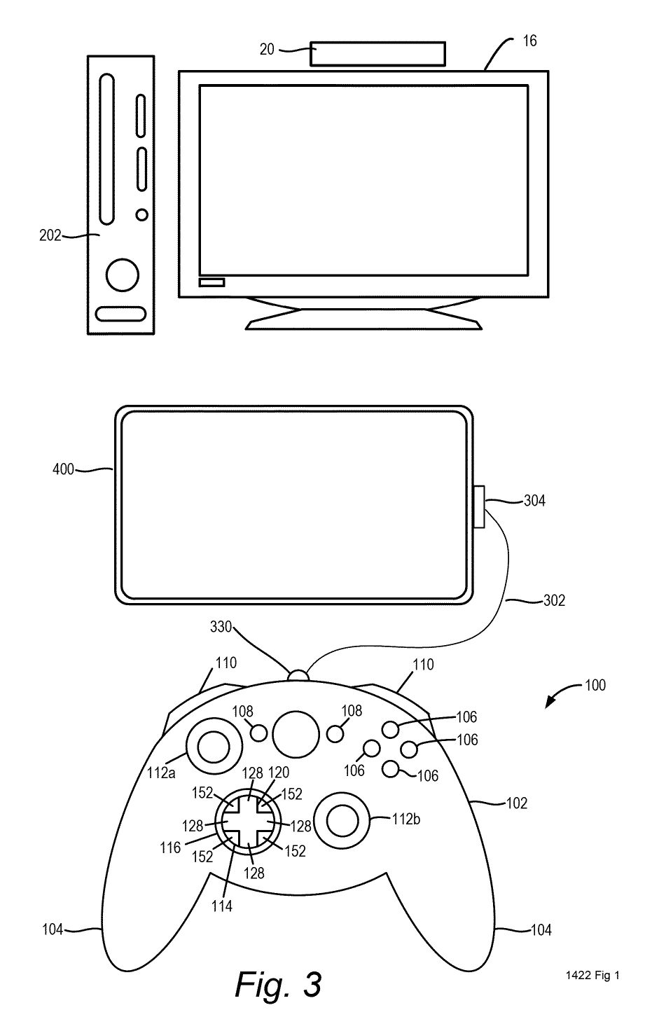

FIG. 3 illustrates an exemplary embodiment of a tactile controller 100 with a touch sensitive device 400 to provide a secondary media control experience. As illustrated in FIG. 3, a user may view content on display 16 using consoles 202. Controller 100 may comprise a controller for an “Xbox” device.

FIG. 3 is a top view of a controller 100 having a tactile or manual input. Although a specific controller is described, it is not intended to be limiting as numerous types of controllers may be used. Controller 100 includes a housing or body 102 forming a majority of the exterior surface of the controller having a shape to interface with the hands of a user. A pair of hand grips 104 extend from a lower portion of the body. A set of input or action buttons 106 are positioned at an upper right portion of the body. These input buttons may be referred to as face buttons due to their orientation on the top face of the body 102 of the controller. The input buttons may be simple switches generating a signal having a binary output to indicate selection by a user. In other examples, the input buttons may be pressure-sensitive switches that generate signals indicating different levels of selection by the user. Additional input buttons 108 are provided at an upper central position of the body and may provide additional functions, such as for navigating a graphical user interface menu. Input buttons 108 may also provide binary or multi-level response signals. A set of input buttons 110 are provided at an upper face of the controller body 102, often referred to as triggers for their intended actuation by the fingers. In many examples, these types of triggers are pressure-sensitive, but need not be.

A first analog thumb stick 112a is provided at an upper left portion of the face of body 102 and a second analog thumb stick 112b is provided at a lower right hand portion of the face of body 102. Each analog thumb stick allows so-called analog input by determining a precise angle of the thumb stick relative to a fixed base portion. Moreover, the analog thumb sticks measure the amount of movement of the stick at the precise angle in order to generate signals responsive to different amounts of input in any direction.

A directional pad (D-pad) 114 is formed in a recess 116 at a center left portion of the face of body 102. In other examples, the D-pad may be formed above the controller surface without a recess. The D-pad includes an actuation surface comprising a cross-shaped input pad 120 and four fill tabs 152. In this example, the input pad includes four input arms 128. In other examples, the input pad may include more or less than four input arms. In one example, the D-pad allows a user to provide directional input control for four distinct ordinate directions (e.g., NSEW) corresponding to the four input arms 128.

The actuation surface topology of D-pad 114 is configurable by a user. In one example, the fill tabs 152 are moveable with respect to input pad 120 to change a distance between the upper surface of input pad 120 and the upper surface of the fill tabs. In this manner, the actuation surface topology of the D-pad may be altered by a user. With the fill tabs 152 in an upward position with respect to the input tab 120, a circular or platter-shaped actuation configuration is provided, and with the fill the tabs in a lowered position with respect to the upper surface of the input tab, a cross-shaped actuation configuration is provided.

In one embodiment, input pad 120 and fill tabs 152 are rotatable within recess 116 about a central axis of the directional pad extending perpendicular to a central portion of the actuation surface. Rotation of input pad 120 and fill tabs 152 causes linear translation of the fill tabs parallel to the central axis. By rotating directional pad 114 in a clockwise or counter clockwise direction about the central axis, the surface topology of actuation surface 118 can be changed. The linear translation of the fill tabs changes the distance between the upper surface of input arms 128 and the upper surface of fill tabs 152, thus altering the actuation surface topology of the directional pad.

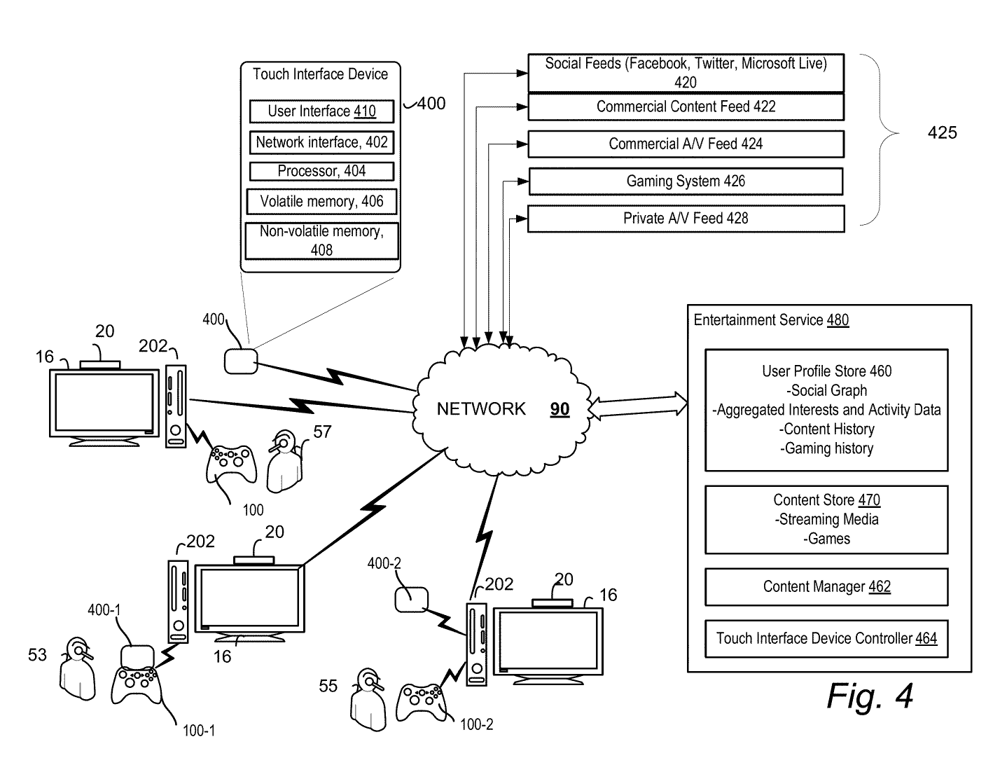

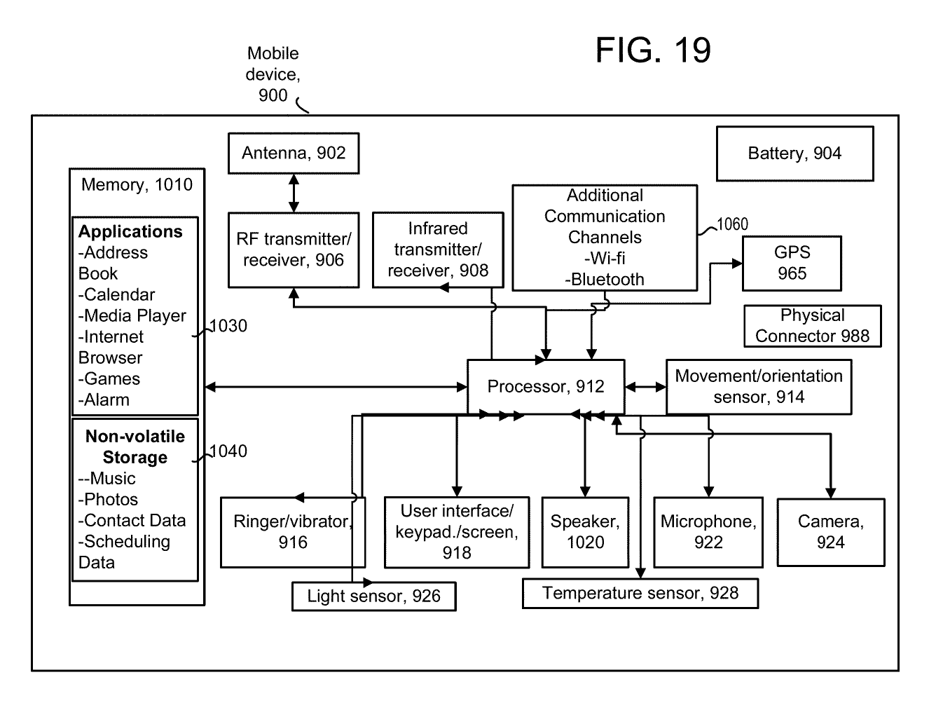

Device 400 may be a touch enable processing device such as that described below with respect to FIG. 4 and FIG. 19. The touch enabled processing device may be coupled to console 202 wirelessly, via an Internet connection, or via a cable 302 and connector 304. Device 400 may interact with controller 20 or controller 100 to provide a secondary experience in conjunction with the content 14 consumed on main display 16 and the console 202.

FIG. 4 is a block diagram illustrating a system suitable for implementing the present technology. FIG. 4 illustrates a variety of use cases and various components of the system. Shown in FIG. 4 are users 53, 55, 57, each interacting with their own display 16 primary processing device 202, and one or more controllers. Each of the users consumes content which may be provided by, for example, an entertainment service 480 or third party providers 425. The entertainment service may comprise a content store 470 which can include a library of streaming media, games and other applications for use by users 53, 55, 57. The entertainment service may contain a user profile store 460 which contains records of information concerning the on-line and content consumption activities of each user of the service 480. The user profile store 460 may include information such as the user's social graph culled from online activity and third party social network feeds 420, as well as the user's participation in gaming applications provided by the entertainment service 480. A content manager 462 can determine relationships between different types of content 470 and other users of the same or similar content, provided by the entertainment service 480, as well as activities which users 52, 55, 57 engage with when using any of the processing devices discussed herein.

Third party content providers 425 may be displayed by the consoles 202 directly or consumed through service 480. These providers 425 may include as social network feeds 420, commercial content feeds 422, commercial audio video feeds 424, other gaming systems 426, and private audio/visual feeds. Examples of commercial content services 422 include news service feeds from recognized news service agencies, and RSS feeds. Commercial audio video services 424 can comprise entertainment streams from broadcast networks or other commercial services providing streaming media entertainment. Gaming services 426 can include content from gaming services other than those provided by entertainment service 480. Private audio video feeds 428 can include both audio/visual feeds available through social networks and those available through commercial audio video web sites such as YouTube.

Entertainment service 480 may also include a touch interface device controller 464. The touch interface device controller can determine the user interface 410 which should be presented on an interface device 400. The touch interface device controller 464 can provide instructions to the touch interface device 400 to allow the touch interface device to provide a secondary experience, such as to render the user interface and provide control instructions back to the entertainment service or the third party services to control content which is presented on respective display devices 16.

As illustrated in FIG. 4, a touch interface device 400 can be coupled to the processing system 202 and the entertainment service in a variety of ways. As illustrated with respect to user 53, a touch interface device 400-1 is integrated with a controller 100-1 by physically attaching the device 400-1 to the controller 100-1. Various examples of physical coupling are described below, but can include tethering by means of a cable, physically connecting the devices by means of a cable, physical connecting the devices by means of interface ports on each device, or a fully integrated touch interface device built into the controller 100. As illustrated with respect to user 55, a touch interface device 400-2 may communicate wirelessly with a controller 100-2. Similarly, controller 100-2 may communicate wirelessly with a console 202 and instructions to the touch interface device can be provided from the interface device controller 464 via the console 202 or directly from the console 202. As illustrated with respect to user 57, a touch interface device 400 can communicate directly with network 90, which may be a combination of public and private networks such as the Internet, and receive instructions either from a console 202 or from the interface device controller 464. Controller 100, in the user 57 embodiment, also communicates with console 202. In alternative embodiments controller 100 can communicate with network 90 to control both console 202 and content provided from the content store 470 as well as third party systems 425.

As shown in FIG. 4, the general components of a touch interface device 400 will include a processor 404 which may execute instructions for providing a user interface 410, a network interface 402, volatile memory 406 and non-volatile memory 408. The various capabilities of the touch interface device 400 will be described herein. Methods described below may be converted to instructions operable by processor 404 as well as console 202, controller 100 and controller 20 to enable the methods described herein to be executed and implemented.

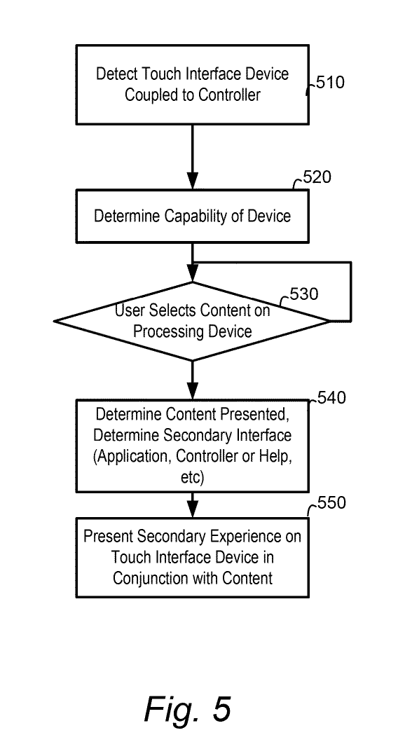

FIG. 5 illustrates a general flow chart of a method in accordance with the present technology. The 510, a touch interface device is coupled to a controller such as controller 100 and the capabilities of the touch interface device can be determined. In some embodiments, the touch interface device is integrated in the controller and step 510 need not be performed.

In some embodiments, touch interface device 400 can constitute any of a number of different processing devices such as smart phones and media players which have universal connection ports or wireless connection capabilities allowing them to be coupled to a controller or to the console 202, or to the network 90 and service 480. In such cases, the capabilities of the device are ascertained at 520. In one embodiment, the touch interface device is an integrated device, or a known device designed to be utilized specifically with a controller 100. In such embodiments, step 520 need not be performed.

At 530, the user selects to receive or participate in content provided from service 480 or of third parties or in conjunction with a processing device such as console 202. At 540, a determination is made as to the type of secondary experience which may be presented on the touch interface device, if any, based on the type of content presented. Various examples of secondary experiences are described below. If the content is presented from the service 480, the service 480 will know which content is being presented to the user and can determine whether secondary content, a user interface or controller, or some other secondary experience should be provided to the touch interface device 400. If the content is provided from third party services, the console 202 may provide feedback to the service 480 and the service 480 then can determine which secondary experience should be provided to the user. At 550, the secondary experience is presented on the interface device in conjunction with the content presented.

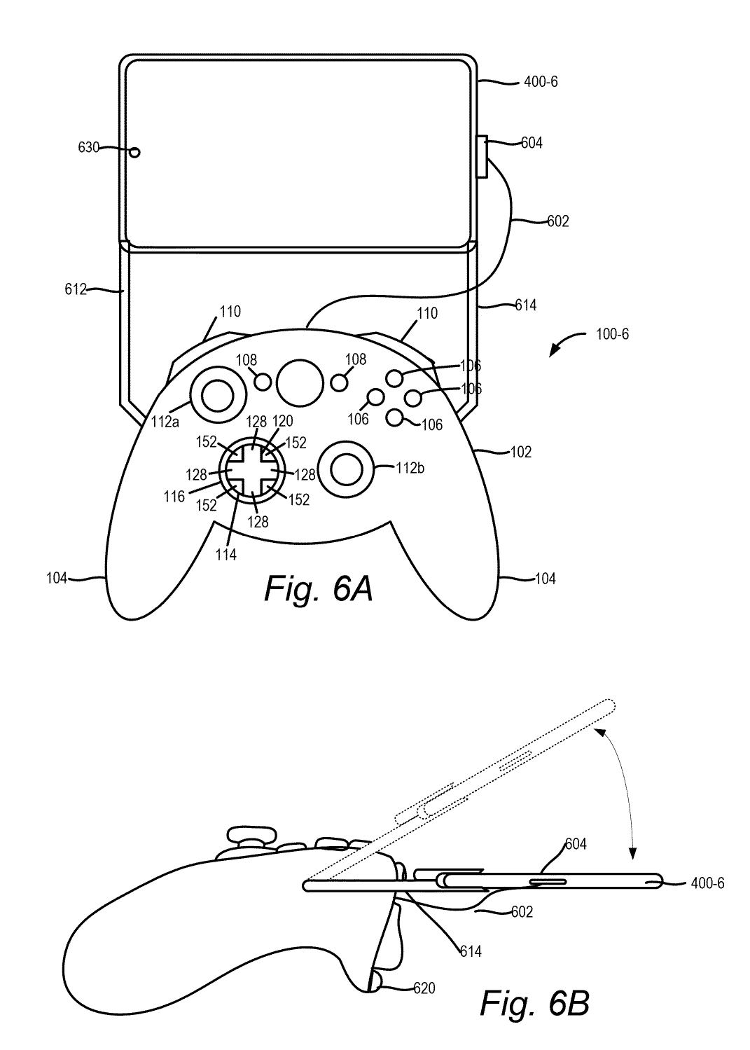

FIGS. 6A and 6B illustrate one alternative for connecting a touch interface device 400-6 to a controller 100-6. In FIGS. 6A and 6B, touch interface device 400-1 is any of a number of generic devices which can be utilized in conjunction with a controller 100-6. Controller 100-6 is generally equivalent to controller 100 discussed above and is equipped with a connector for cable 602 which can be adapted for use with any of a number of different interface devices using a plug 604. The connector may be a standard connector, such as a USB or mini USB connector.

In FIGS. 6A and 6B, a hardware mount 610 comprising arms 612 and 614 is utilized to connect the touch interface device 400-6 to controller 100. In this manner, the touch interface device 400-6 can be any generic touch interface device and can be utilized by the user of controller 100 to receive a secondary experience with respect to a content presentation on a display. One end of each arm 612, 614 may be inserted into corresponding coupling holes in controller 100-6, and a second end of each arm may include a bracket securing the touch interface device 400-6 in relation to controller 100-6. As illustrated in FIG. 6b, the mount 610 may allow the touch interface device 400-6 to be positioned at various angles with respect to controller 100-6.

Touch interface device 400-6 may include a camera 630 positioned on the face of the device relative to the touch sensitive surface. As is well known, many touch devices include a second camera on the back surface of the device. The positioning of the device at angles relative to the controller 100-6 allows a different field of view for the camera and provides alternative inputs for the service 480 to provide various secondary experiences as described below.

As illustrated in FIG. 6B, controller 100-6 may also include a forward facing camera 620. Forward facing camera has a field of view toward the direction that the controller is pointed. This gives system 480 multiple fields of view and adds to the functionality of the system as described below.

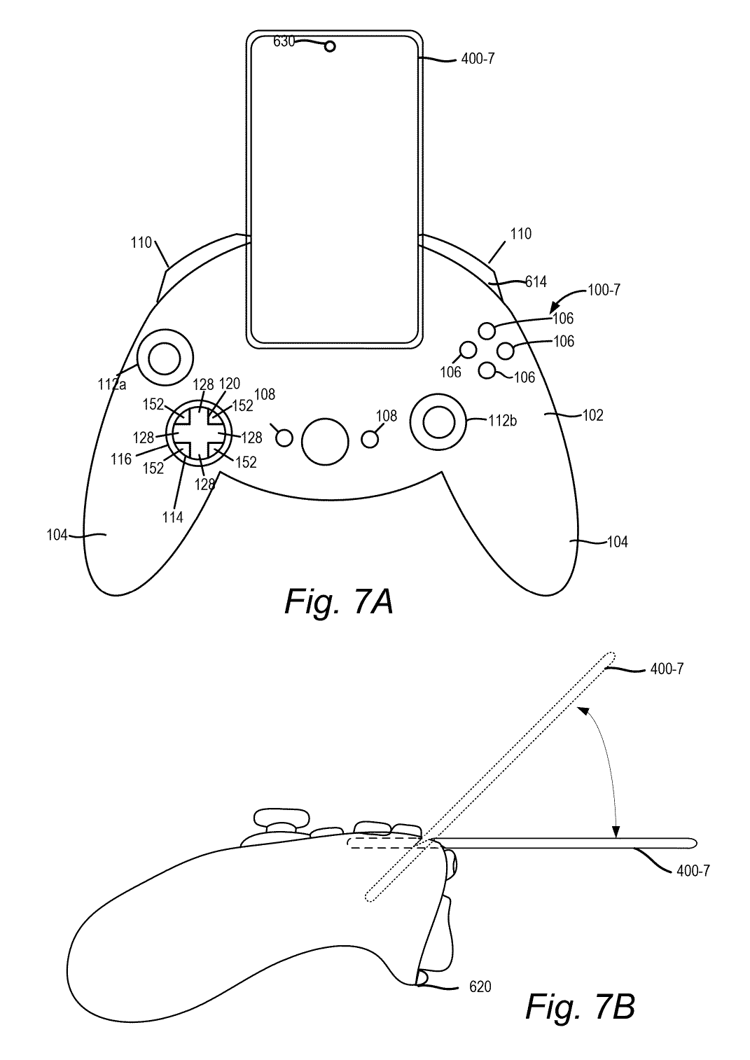

FIGS. 7A and 7B illustrate a second touch interface device 400-7 which has been adapted to be received into a slot 704 in controller 100-7. In this embodiment, a physical connector on the touch interface device 400-7 and a physical connector on the controller 100-7 mate in a manner to allow electrical connection between the two devices. Slot 704 provides structural rigidity for the interface device 400-7. In addition, it will be noted that the orientation of device 400-7 is in a “portrait” mode with respect to controller 100-7. Alternative embodiments are discussed below.

As illustrated in FIG. 7B, slot (or other coupling component) may be adapted to allow the touch interface device 400-7 to have a varied angle with respect to the controller 100-7. FIG. 7A likewise illustrates a camera 630 on touch interface device 400-7 as well as a camera 620 on controller 100-7.

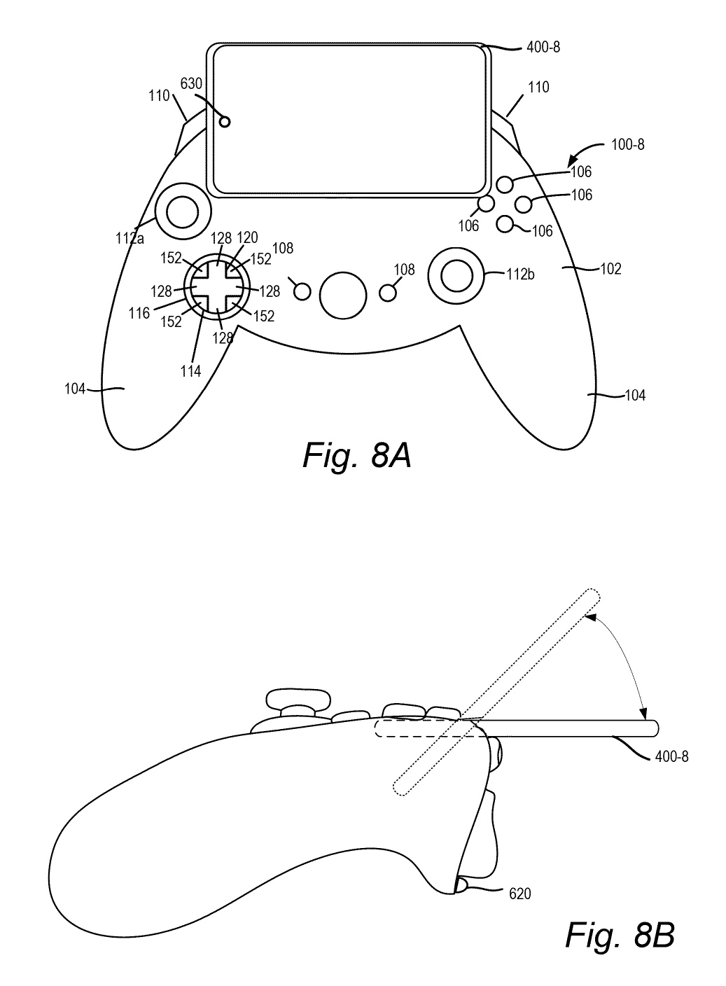

As shown in FIGS. 8A and 8B, controller 100-8 has been adapted to receive a landscape mounted interface device 400-8. Device 400-8 may be configured to be inserted into one or more connections in controller 100-8 and controller 100-8 includes all the tactile elements provided as discussed above. Touch interface device 400-8 can be a specific touch interface device adapted for use with controller 100-8, or controller 100-8 can be adapted to receive any of the number of different devices using standard connections. Again, as illustrated in FIG. 8B, slot (or other coupling component) may be adapted to allow the touch interface device 400-8 to have a varied angle with respect to the controller 100-8.

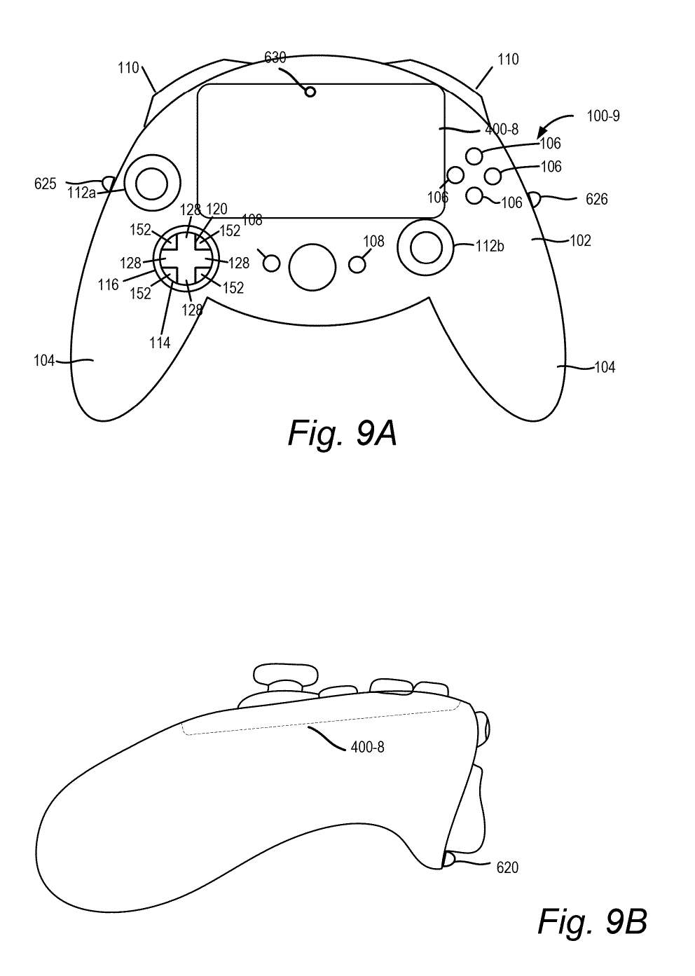

FIGS. 9A and 9B illustrate another controller 100-9 with an integrated touch interface device 400-9. Integrated touch interface device 400-9 should now be considered a separate interface device but could be considered as a touch interface screen integrated in and on controller 100-9. The processing components of the generic interface device 400 illustrated in FIG. 4 may be present in this embodiment. Again, the controller 100-9 illustrates all the tactile control elements of other embodiments.

FIGS. 9A and 9B illustrate the use of additional cameras positioned at other portions of the controller such as shown in FIG. 9 with cameras 630 and 640 providing alternative views of the user's environment which may be utilized in the secondary experience as described below. It will be understood these cameras may be provided on any of the various embodiments described herein.

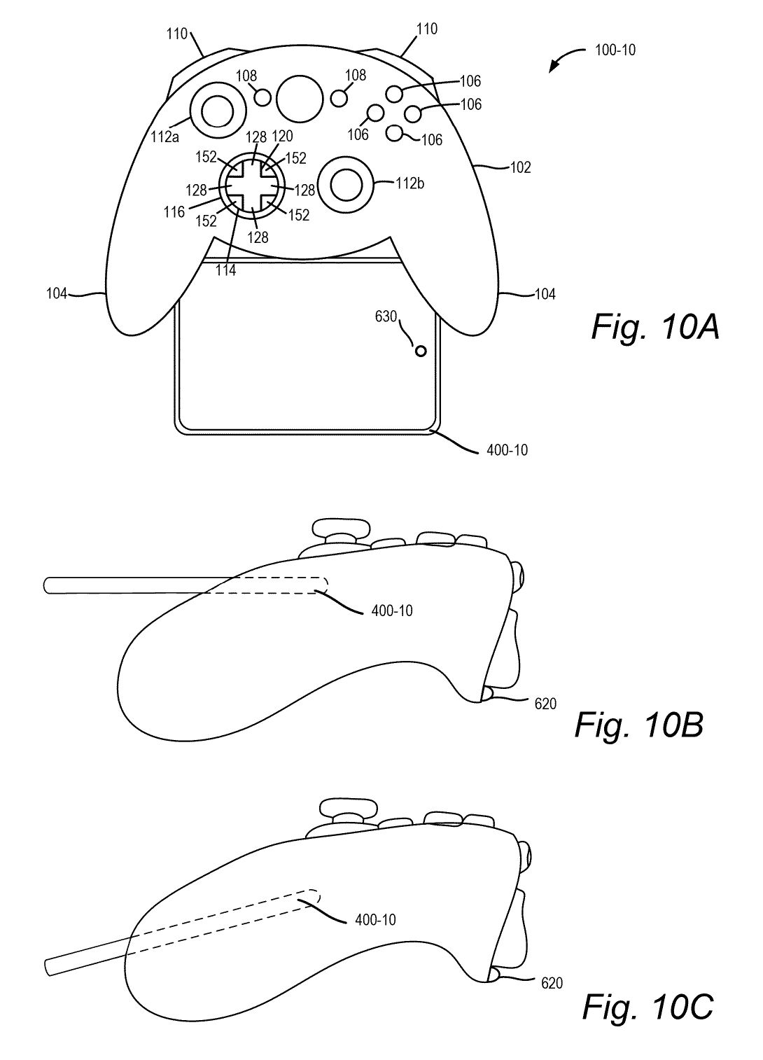

FIGS. 10A-10C illustrate an alternative positioning of a touch interface device 400-10 with respect to a controller 100-10. Shown therein, controller 100-10 mounts the touch interface device 400-10 below the hand grips 104. As illustrated in FIGS. 10A and 10B, the angle at which the controller is provided may be selected based on physical adjustments within the controller, providing alternative slots in the controller for entry of the device, or other mechanical components which allow the user to adjust the angle of the screen.

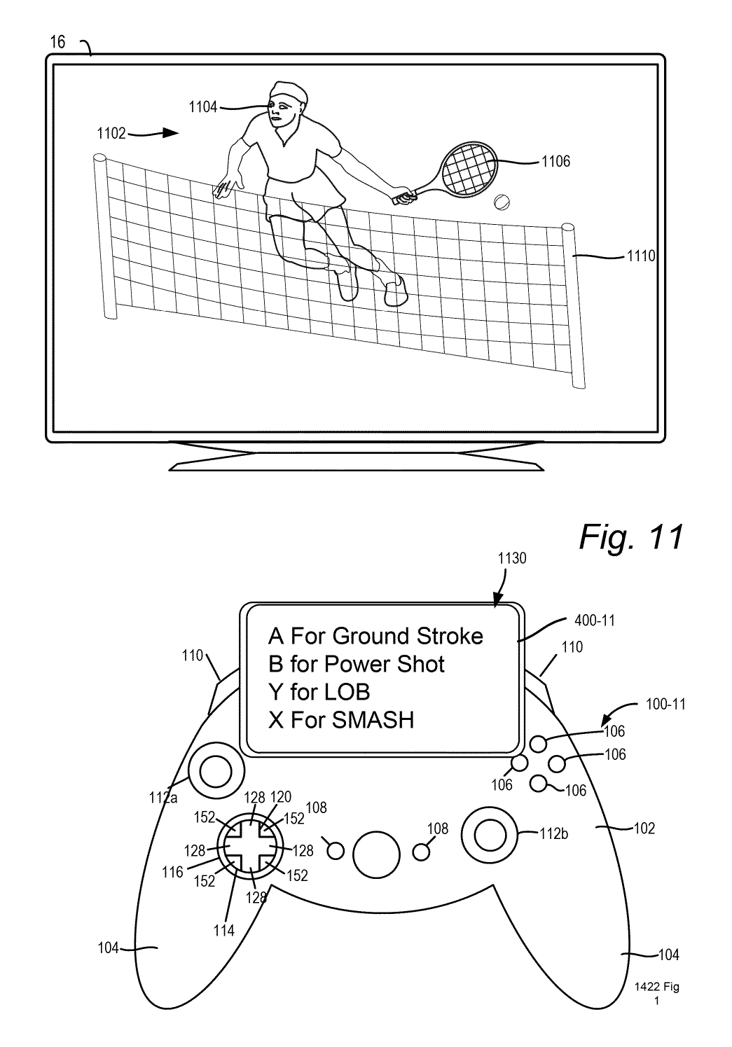

FIGS. 11-17 illustrate various examples of a secondary interface provided on a touch display controller. The secondary interface may be adapted for use with the content being consumed by the user. The below descriptions are exemplary, and any number of different secondary interfaces may be provided based on the type of content selected. Generally, these include user help interfaces, secondary controller interfaces or alternative view interfaces. Secondary controller interfaces may provide an alternative set of control signals for game controls which are not provided by tactile control elements, or alternative control means as alternatives for the tactile control elements. As such, for a set of control signals for content which are provided by the controller and touch display, one sub-set may be provided by the tactile controller and a second sub-set provided by the touch display interface. These sub-sets may be completely separate, may overlap partially or overlap completely. For example, as discussed below, in a game application, an alternative user interface, or help screens, may be provided in conjunction with a game. In a streaming media environment, additional guide information relevant to the streaming media may be presented. In addition, alternative forms of controllers or supplemental information can be provided, all within the context of the type of media or content which is being consumed by the user.

FIG. 11 illustrates an exemplary view which may be seen by a user in conjunction with a secondary experience while playing a game on a display 16. Display 16 illustrates a tennis game 1102 showing a tennis player 1104 above to hit a ball 1106 relative to a net 1110. As will be generally understood, during a tennis game a user has a variety of strokes which they may play relative to the ball, and the controllers 112A and 112B can be utilized to position the player as well as perform different types of shots by entering the corresponding button entries on buttons 106. FIG. 11 illustrates an example of the secondary interface comprising a help screen 1130 where the user is provided with instructions on how to use the controller in relation to the game. In this context, the instructions are relative basic in relation to the game. In another context, because the service 480 is controlling the game and is aware of where the user participates in the game, the context of the help screen 1130 can change. For example, in a role playing game, where a user is challenged to complete several different types of challenges within a game, if a user fails a specific challenge a certain number of times, the secondary interface can prompt the user to indicate whether the user would wish to see how other members or participants in the game have solved this level. This can include a video walk-through, step-by-step instructions, basic hints or suggestions, or any other alternative types of help without disturbing the main experience of the game 1102 which is appearing on display 16.

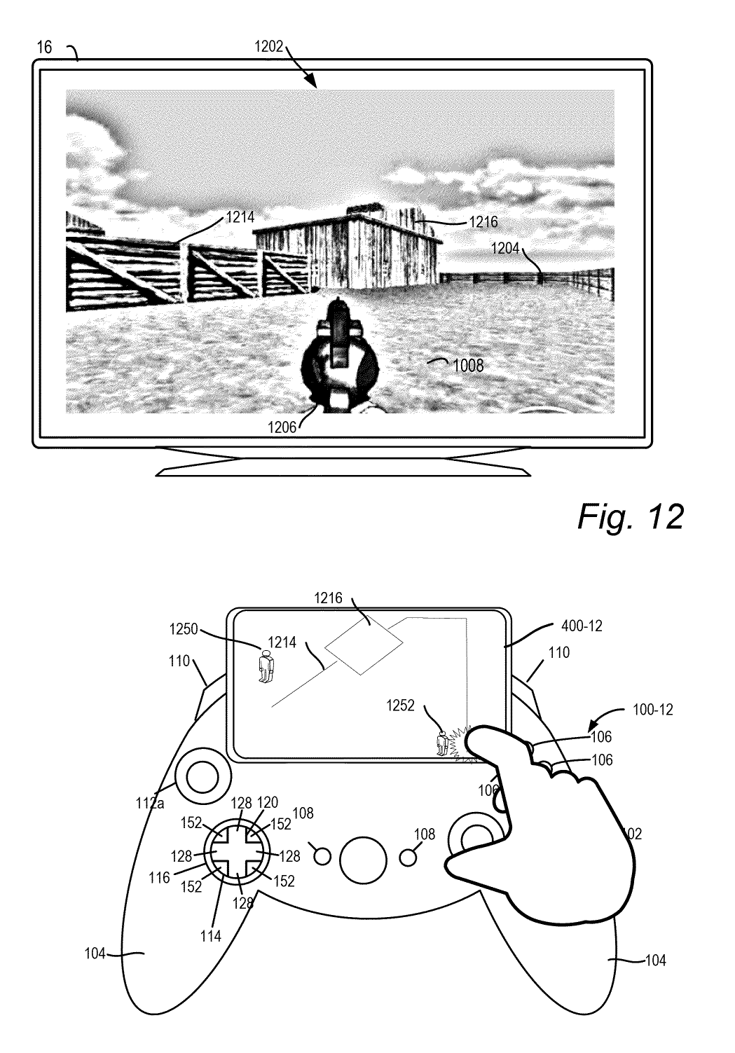

FIG. 12 illustrates a scenario where the user playing a role playing game with a first person view 1202 can control other members in a team environment. Role playing game view 1202 provides a first person view over a weapon 1206 into an environment. As illustrated in FIG. 12, the environment on display 16 includes fence 1204, 1214, a building 1216 and other elements. Some of these elements, as well as other players, may exist in the world of the game but may be outside the first person field of view 1202.

In this example, the secondary experience provided on display 400-12 shows two other users 1250 and 1252 who may be on the user's team. One example of the secondary interface allows the operator of controller 100-12 to position the other users 1250 and 1252 if they are members of a team-based game and the operator of controller 100-12 is the controlling player. To position a team mate, one may drag the teammate to a different location by, for example, touching the user teammate and moving the user teammate to a requested position by sliding the user's finger across the touch interface screen 400-12. Various types of team scenarios can be utilized in conjunction with a secondary experience. For example, the screen may do more than simply control the position of players on the screen. The screen may allow a user to communicate with other members both visually and audibly. Touching a user 1252 may open an audio channel to that team member to tell the team member instructions via audio communications. Alternatively, touching a user 1252 may give rise to a menu with preprogrammed instructions selected by the operator of controller 100-12 which the user of controller 100-12 needs to merely select to communicate those instructions to their teammate. Alternatively, the secondary interface may simply provide a top-view map of the environment showing element which cannot be seen in the first person view. In yet another alternative, touching the interface 400-12 may provide additional information or help tips about the objects in the secondary interface.

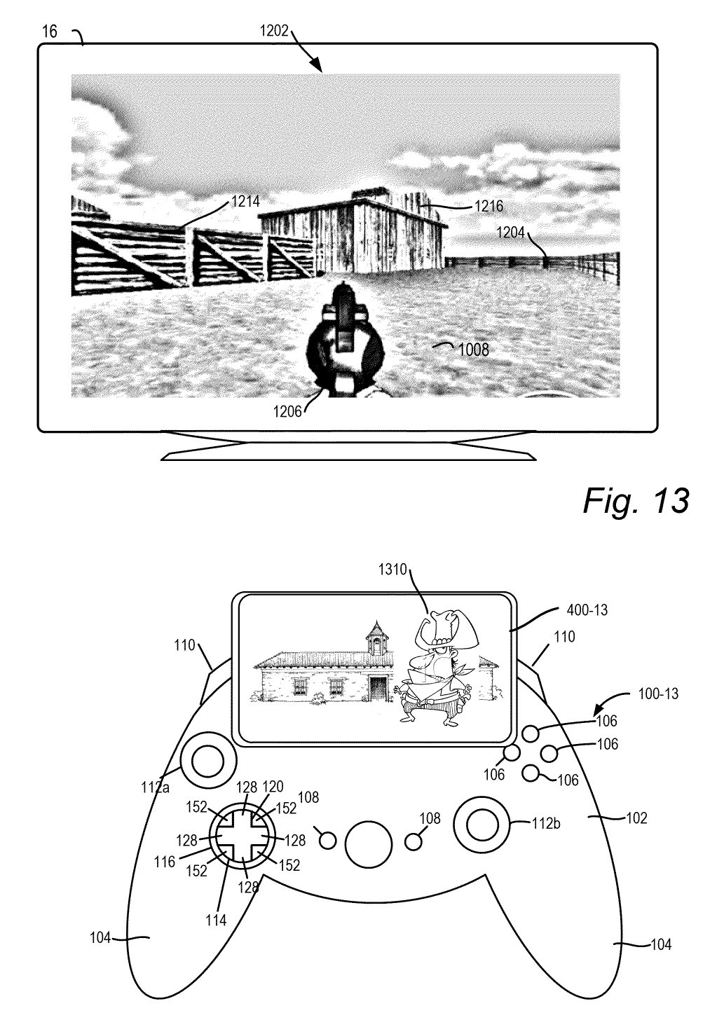

FIG. 13 illustrates a second scenario using a role playing game similar to that shown in FIG. 12. In this case the user is provided with an alternative first person view of the game environment on interface 400-13 which can comprise a rear view of what is occurring behind the user. In this example, the user can see that a potential hazard in the form of another character 1310 is behind the operator of controller 100-13 in the virtual environment of the game view 1202. The character 1310 appears only on the secondary interface in the secondary experience 400-13 unless the user controls the interface to “turn around” and look to the rear in the virtual environment. Alternatively, interface 400-13 can utilizes the cameras discussed above to provide alternative views of the user's own environment or show alternative data which it interprets from real world people within the user's sphere and bring those environment variables into the gaming experience.

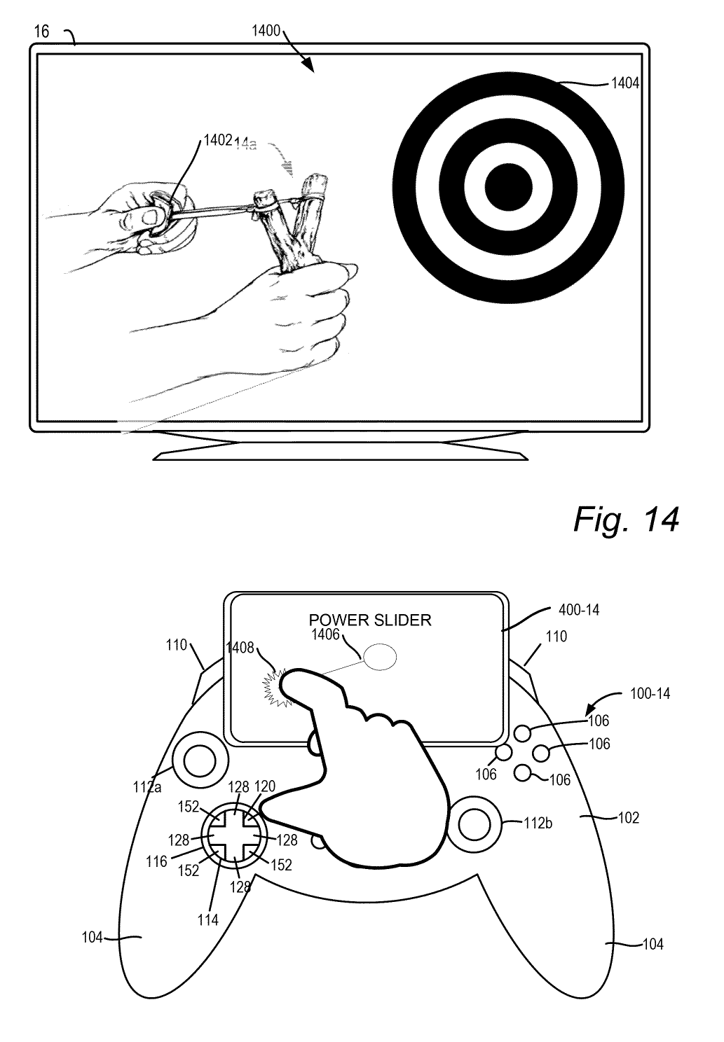

FIG. 14 illustrates an embodiment utilizing an alternative control means which may be more advantageous for certain types of games than the tactile controls found on controller 100-14. In a game where a user control would be aided by an analog input, such as a slider or dial, the touch interface 400-14 can be utilized. The touch interface 400-14 in this embodiment is utilized to play a targeting game 1400 which appears on display 16. In this game, a user must pull back their slingshot 1402 to achieve a sufficient velocity of the projectile to hit a target 1404. FIG. 14 shows a power slider interface on device 400-14 where a user slides their finger from an initial contact point 1406 to a second contact point 1408 and releases their finger from the screen of device 400-14 to release the projectile in the game 1400. Such analog controls can be more easily presented and allow the user control options on device 400-14.

In the example of FIG. 14, a game may provide the same targeting and control mechanism as interface 400-14 through tactile controls. Hence, in such embodiment, a set of control signals form the tactile device and one from the interface 400-14 may overlap.

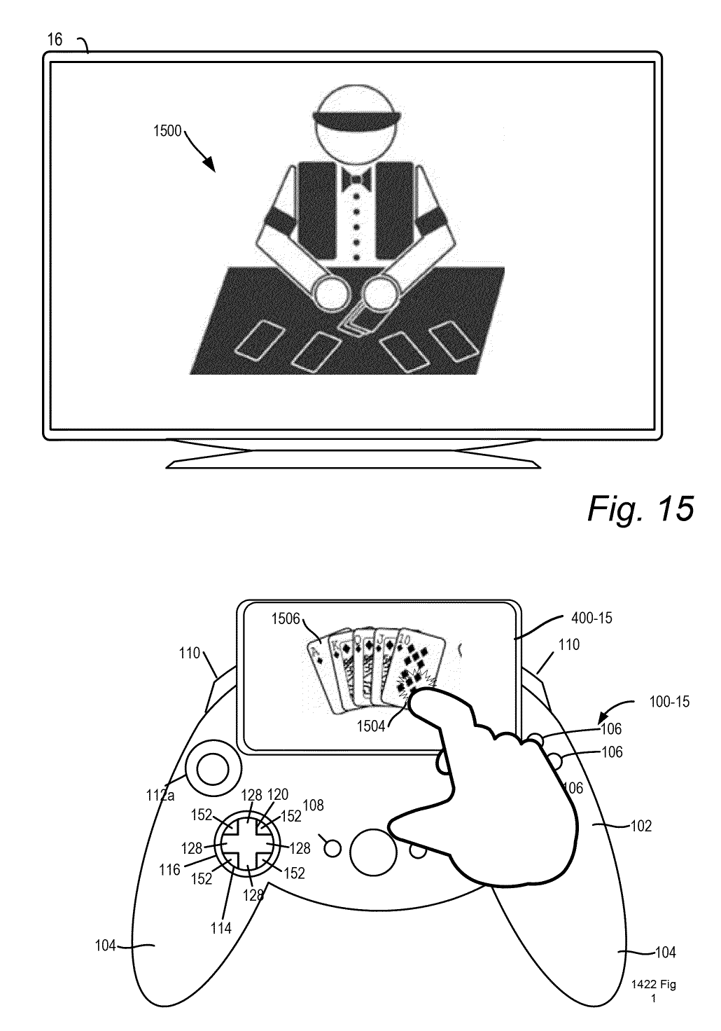

FIG. 15 illustrates yet another embodiment of a secondary experience which may be implemented either by the tactile controls on controller 100-15 or on the interface 400-15. In a poker game 1500, a user generally does not want other users in the game to be aware of their cards. The operator of controller 100-15 may have their cards presented to them in touch interface 400-15. A user can utilize touch inputs 1504 on card 1506 on the user's own device which cannot be seen by other players in the game to participate in the card game 1500 on a display 16, even where the display is shared by all players in the game. Such an embodiment is useful in a scenario such as that shown in FIG. 2 where two users playing the same game but who have secret information which they do not want shared with other players in the game need access to their own information. The interface 400-15 may be a partial or complete alternative to use of tactile controls on controller 100-15.

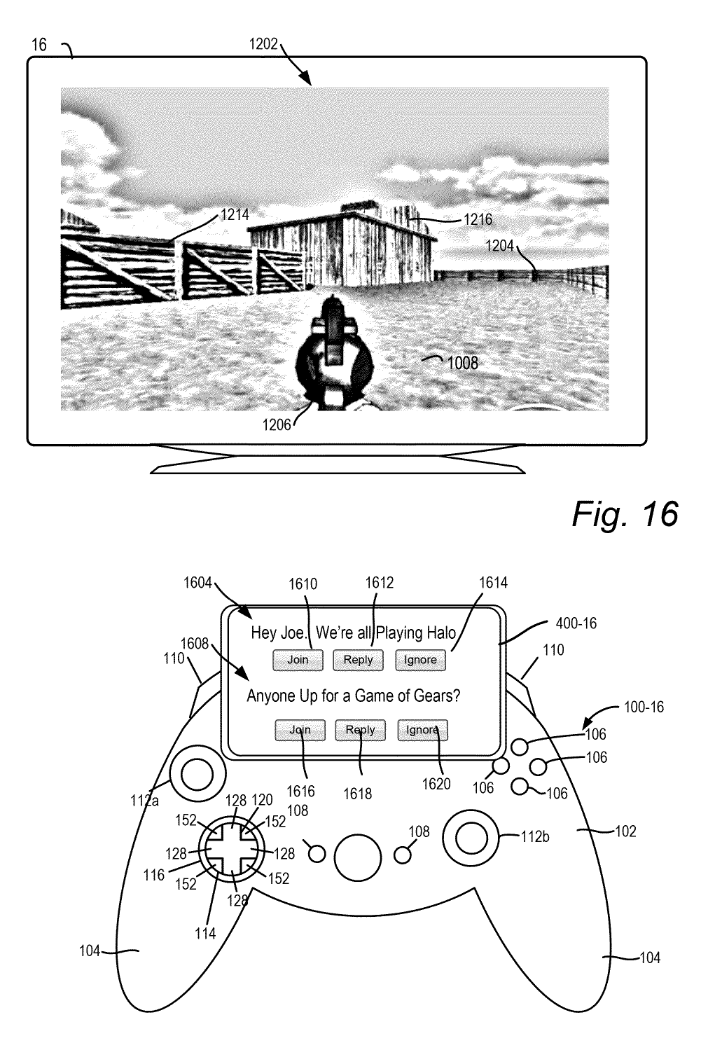

FIG. 16 illustrates another secondary experience comprising a notification system. In FIG. 16, the secondary experience on display 400-16 includes a notification that other users are waiting for the operator of controller 100-16 to play a different game. In this scenario, the operator of controller 100-16 is playing the role playing game with view 1202 discussed above. However, other users may send the operator of controller 100-16 messages 1604 and 1608 asking the user whether they wish to participate in other types of games, or any other type of notification. Depending on the type of notification, soft response control buttons 1610, 1612, 1614, 1616, 1618 and 1620 can be provided to allow the operator of controller 100-16 to easily respond to the notifications or simply ignore the notifications. It will be recognized that any number of different types of notifications and notification controls may be implemented on the secondary experience.

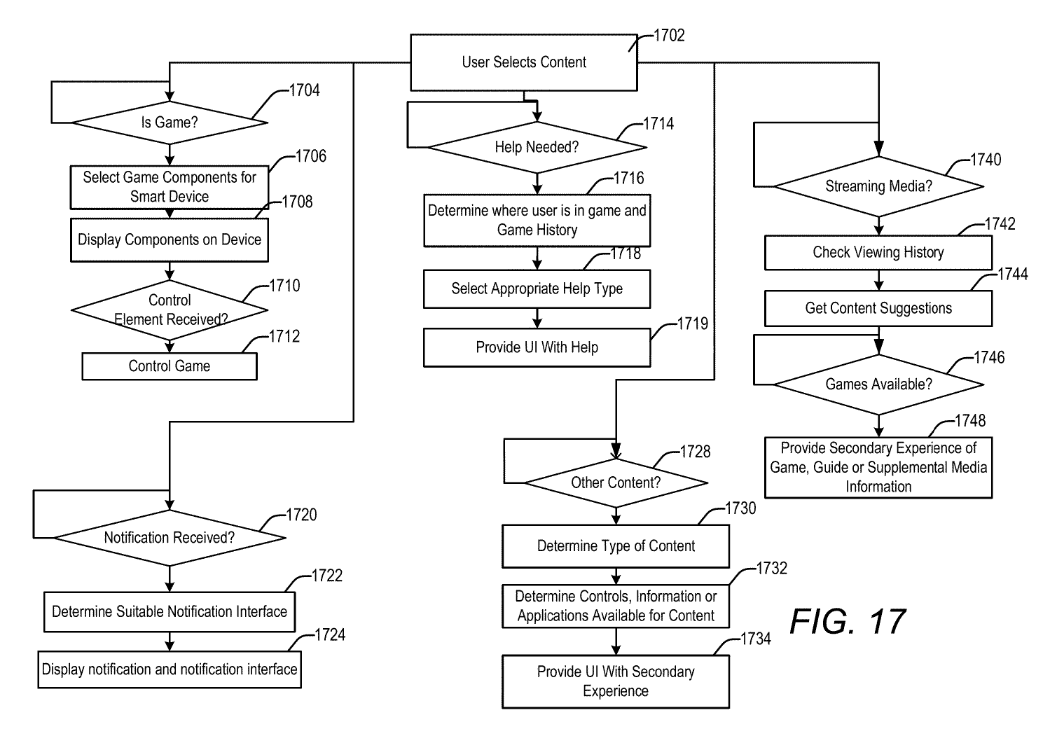

FIG. 17 illustrates a flow chart of highlighting the various different embodiments more specific method in accordance with the present technology. At step 1702, the user selects content which is to be presented to the user or participated in by the user. Based on the content selected, a secondary experience is generated and presented to a touch interface device.

If the content is a game at 1704, then service 480 will select components for the secondary experience which should be displayed to the user at 1706. The service will send these components to the touch interface device at 1708. Once the control element is received at 1710, then the user may utilize these control elements to control the game at 1712. Control elements in the secondary experience on the touch interface device will generate control signals which will be returned to the service 480 to control the game in accordance with the particular requirements of the game.

If the content requires a help screen, a prompt to display help may be provided at 1714. At 1716, when a help screen is called, the service 480 may determine where the user is in the game, application or other content, and the user's history with the game application or content. This can aid the service 480 in providing the correct type of help, or options for the user to request different types of help. At 1718, the appropriate help type is selected. The appropriate help type can be selected automatically by the gaming service 480, or the user may be prompted to select a particular help type which can then be displayed at 1719. Help may take many forms, including those discussed above. In addition, a user may be played a video of how to perform a task in a game, or shown how other users solved an issue with an application.

After the user selects content at 1702, a notification may be received at 1720. At 1722, a determination of whether the notification is of a type that a user may wish to view may be made by service 480. Any number of filters may be used to make this determination. For example, all notification messages received from particular levels of a user's social graph may be allowed to pass through. Users may have specified that they do not wish to receive certain classifications of notifications, such as invitations to play games. Once the system determines whether the notification should be provided, the system may display the notification in an appropriate matter at 1722.

As will be understood by one of average skill, a number of types of content may be provided by the service 480 or third party providers. For any type of content at 1728, once the service 480 determines the type of content it is at 1730, a secondary experience can be provided at 1732. At 1732, the system determines the controls, information or applications suitable for use in the secondary experience and at 1734, provides the secondary UI experience to the touch screen controller. As noted, the service 480 can determine the user's viewing history and other online activity in conjunction with the currently streamed content by feedback from the user directly or consoles 202, and this feedback can be utilized to provide a secondary interface in different contexts.

FIG. 18 illustrates an example of a suitable computing system environment which may be used in the foregoing technology as any of the processing devices described herein. Multiple computing systems may be used as servers to implement the place service.

With reference to FIG. 18, an exemplary system for implementing the invention includes a general purpose computing device in the form of a computer 710. Components of computer 710 may include, but are not limited to, a processing unit 720, a system memory 730, and a system bus 721 that couples various system components including the system memory to the processing unit 720. The system bus 721 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 710 typically includes a variety of computer readable media. Computer readable media can be any available media that can be accessed by computer 710 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 710.

The system memory 730 includes computer storage media in the form of volatile and/or nonvolatile memory such as read only memory (ROM) 731 and random access memory (RAM) 732. A basic input/output system 733 (BIOS), containing the basic routines that help to transfer information between elements within computer 710, such as during start-up, is typically stored in ROM 731. RAM 732 typically contains data and/or program modules that are immediately accessible to and/or presently being operated on by processing unit 720. By way of example, and not limitation, FIG. 7 illustrates operating system 734, application programs 735, other program modules 736, and program data 737.

The computer 710 may also include other removable/non-removable, volatile/nonvolatile computer storage media. By way of example only, FIG. 18 illustrates a hard disk drive 740 that reads from or writes to non-removable, nonvolatile magnetic media, a magnetic disk drive 751 that reads from or writes to a removable, nonvolatile magnetic disk 752, and an optical disk drive 755 that reads from or writes to a removable, nonvolatile optical disk 756 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 741 is typically connected to the system bus 721 through a non-removable memory interface such as interface 740, and magnetic disk drive 751 and optical disk drive 755 are typically connected to the system bus 721 by a removable memory interface, such as interface 750.

The drives and their associated computer storage media discussed above and illustrated in FIG. 7, provide storage of computer readable instructions, data structures, program modules and other data for the computer 710. In FIG. 18, for example, hard disk drive 741 is illustrated as storing operating system 744, application programs 745, other program modules 746, and program data 747. Note that these components can either be the same as or different from operating system 734, application programs 735, other program modules 736, and program data 737. Operating system 744, application programs 745, other program modules 746, and program data 747 are given different numbers here to illustrate that, at a minimum, they are different copies. A user may enter commands and information into the computer 20 through input devices such as a keyboard 762 and pointing device 761, commonly referred to as a mouse, trackball or touch pad. Other input devices (not shown) may include a microphone, joystick, game pad, satellite dish, scanner, or the like. These and other input devices are often connected to the processing unit 720 through a user input interface 760 that is coupled to the system bus, but may be connected by other interface and bus structures, such as a parallel port, game port or a universal serial bus (USB). A monitor 791 or other type of display device is also connected to the system bus 721 via an interface, such as a video interface 790. In addition to the monitor, computers may also include other peripheral output devices such as speakers 797 and printer 796, which may be connected through an output peripheral interface 790.

The computer 710 may operate in a networked environment using logical connections to one or more remote computers, such as a remote computer 780. The remote computer 780 may be a personal computer, a server, a router, a network PC, a peer device or other common network node, and typically includes many or all of the elements described above relative to the computer 710, although only a memory storage device 781 has been illustrated in FIG. 7. The logical connections depicted in FIG. 7 include a local area network (LAN) 771 and a wide area network (WAN) 773, but may also include other networks. Such networking environments are commonplace in offices, enterprise-wide computer networks, intranets and the Internet.

When used in a LAN networking environment, the computer 710 is connected to the LAN 771 through a network interface or adapter 770. When used in a WAN networking environment, the computer 710 typically includes a modem 772 or other means for establishing communications over the WAN 773, such as the Internet. The modem 772, which may be internal or external, may be connected to the system bus 721 via the user input interface 760, or other appropriate mechanism. In a networked environment, program modules depicted relative to the computer 710, or portions thereof, may be stored in the remote memory storage device. By way of example, and not limitation, FIG. 7 illustrates remote application programs 785 as residing on memory device 781. It will be appreciated that the network connections shown are exemplary and other means of establishing a communications link between the computers may be used.

FIG. 19 is a block diagram of an exemplary mobile device which may operate in embodiments of the technology as the touch interface device. Exemplary electronic circuitry of a typical mobile device is depicted. The mobile device 900 includes one or more microprocessors 912, and memory 1010 (e.g., non-volatile memory such as ROM and volatile memory such as RAM) which stores processor-readable code which is executed by one or more processors of the control processor 912 to implement the functionality described herein.

Mobile device 900 may include, for example, processors 912, memory 1010 including applications and non-volatile storage. Applications may include the secondary interface which is provided to the user interface 918. The processor 912 can implement communications, as well as any number of applications, including the interaction applications discussed herein. Memory 1010 can be any variety of memory storage media types, including non-volatile and volatile memory. A device operating system handles the different operations of the mobile device 900 and may contain user interfaces for operations, such as placing and receiving phone calls, text messaging, checking voicemail, and the like. The applications 1030 can be any assortment of programs, such as a camera application for photos and/or videos, an address book, a calendar application, a media player, an internet browser, games, other multimedia applications, an alarm application, other third party applications, the interaction application discussed herein, and the like. The non-volatile storage component 1040 in memory 1010 contains data such as web caches, music, photos, contact data, scheduling data, and other files.

The processor 912 also communicates with RF transmit/receive circuitry 906 which in turn is coupled to an antenna 902, with an infrared transmitted/receiver 908, with any additional communication channels 1060 like Wi-Fi or Bluetooth, and with a movement/orientation sensor 914 such as an accelerometer. Accelerometers have been incorporated into mobile devices to enable such applications as intelligent user interfaces that let users input commands through gestures, indoor GPS functionality which calculates the movement and direction of the device after contact is broken with a GPS satellite, and to detect the orientation of the device and automatically change the display from portrait to landscape when the phone is rotated. An accelerometer can be provided, e.g., by a micro-electromechanical system (MEMS) which is a tiny mechanical device (of micrometer dimensions) built onto a semiconductor chip. Acceleration direction, as well as orientation, vibration and shock can be sensed. The processor 912 further communicates with a ringer/vibrator 916, a user interface keypad/screen 918, one or more speakers 1020, a microphone 922, a camera 924, a light sensor 926 and a temperature sensor 928. The user interface, keypad and screen may comprise a capacitive touch screen in accordance with well know principles and technologies.

The processor 912 controls transmission and reception of wireless signals. During a transmission mode, the processor 912 provides a voice signal from microphone 922, or other data signal, to the RF transmit/receive circuitry 906. The transmit/receive circuitry 906 transmits the signal to a remote station (e.g., a fixed station, operator, other cellular phones, etc.) for communication through the antenna 902. The ringer/vibrator 916 is used to signal an incoming call, text message, calendar reminder, alarm clock reminder, or other notification to the user. During a receiving mode, the transmit/receive circuitry 906 receives a voice or other data signal from a remote station through the antenna 902. A received voice signal is provided to the speaker 1020 while other received data signals are also processed appropriately.

Additionally, a physical connector 988 can be used to connect the mobile device 900 to an external power source, such as an AC adapter or powered docking station. The physical connector 988 can also be used as a data connection to a computing device and/or various embodiments of the controllers 100 described herein. The data connection allows for operations such as synchronizing mobile device data with the computing data on another device.

A GPS transceiver 965 utilizing satellite-based radio navigation to relay the position of the user applications is enabled for such service.

The example computer systems illustrated in the figures include examples of computer readable storage media. Computer readable storage media are also processor readable storage media. Such media may include volatile and nonvolatile, removable and non-removable media implemented in any method or technology for storage of information such as computer readable instructions, data structures, program modules or other data. Computer storage media includes, but is not limited to, RAM, ROM, EEPROM, cache, flash memory or other memory technology, CD-ROM, digital versatile disks (DVD) or other optical disk storage, memory sticks or cards, magnetic cassettes, magnetic tape, a media drive, a hard disk, magnetic disk storage or other magnetic storage devices, or any other medium which can be used to store the desired information and which can accessed by a computer.

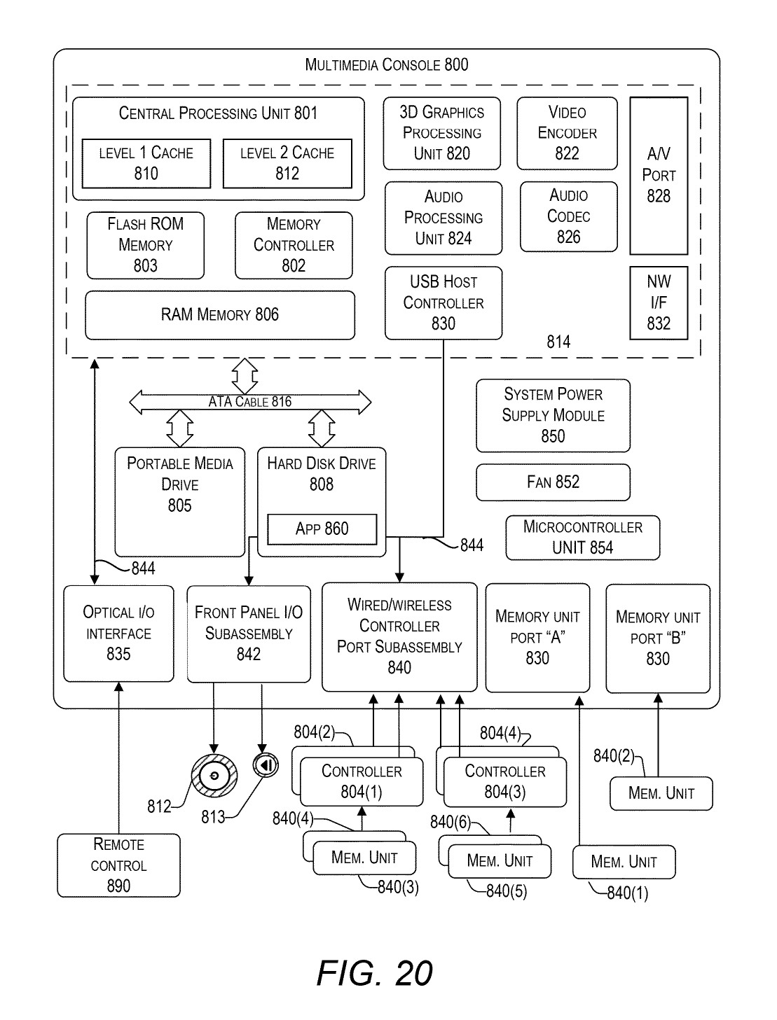

FIG. 20 is a block diagram of another embodiment of a computing system that can be used to implement the console 202. In this embodiment, the computing system is a multimedia console 800, such as a gaming console. As shown in FIG. 20, the multimedia console 800 has a central processing unit (CPU) 801, and a memory controller 802 that facilitates processor access to various types of memory, including a flash Read Only Memory (ROM) 803, a Random Access Memory (RAM) 806, a hard disk drive 808, and portable media drive 806. In one implementation, CPU 801 includes a level 1 cache 810 and a level 2 cache 812, to temporarily store data and hence reduce the number of memory access cycles made to the hard drive 808, thereby improving processing speed and throughput.

CPU 801, memory controller 802, and various memory devices are interconnected via one or more buses (not shown). The details of the bus that is used in this implementation are not particularly relevant to understanding the subject matter of interest being discussed herein. However, it will be understood that such a bus might include one or more of serial and parallel buses, a memory bus, a peripheral bus, and a processor or local bus, using any of a variety of bus architectures. By way of example, such architectures can include an Industry Standard Architecture (ISA) bus, a Micro Channel Architecture (MCA) bus, an Enhanced ISA (EISA) bus, a Video Electronics Standards Association (VESA) local bus, and a Peripheral Component Interconnects (PCI) bus also known as a Mezzanine bus.

In one implementation, CPU 801, memory controller 802, ROM 803, and RAM 806 are integrated onto a common module 814. In this implementation, ROM 803 is configured as a flash ROM that is connected to memory controller 802 via a PCI bus and a ROM bus (neither of which are shown). RAM 806 is configured as multiple Double Data Rate Synchronous Dynamic RAM (DDR SDRAM) modules that are independently controlled by memory controller 802 via separate buses (not shown). Hard disk drive 808 and portable media drive 805 are shown connected to the memory controller 802 via the PCI bus and an AT Attachment (ATA) bus 816. However, in other implementations, dedicated data bus structures of different types can also be applied in the alternative.

A graphics processing unit 820 and a video encoder 822 form a video processing pipeline for high speed and high resolution (e.g., High Definition) graphics processing. Data are carried from graphics processing unit (GPU) 820 to video encoder 822 via a digital video bus (not shown). Lightweight messages generated by the system applications (e.g., pop ups) are displayed by using a GPU 820 interrupt to schedule code to render popup into an overlay. The amount of memory used for an overlay depends on the overlay area size and the overlay preferably scales with screen resolution. Where a full user interface is used by the concurrent system application, it is preferable to use a resolution independent of application resolution. A scaler may be used to set this resolution such that the need to change frequency and cause a TV resync is eliminated.

An audio processing unit 824 and an audio codec (coder/decoder) 826 form a corresponding audio processing pipeline for multi-channel audio processing of various digital audio formats. Audio data are carried between audio processing unit 824 and audio codec 826 via a communication link (not shown). The video and audio processing pipelines output data to an NV (audio/video) port 828 for transmission to a television or other display. In the illustrated implementation, video and audio processing components 820-828 are mounted on module 214.

FIG. 20 shows module 814 including a USB host controller 830 and a network interface 832. USB host controller 830 is shown in communication with CPU 801 and memory controller 802 via a bus (e.g., PCI bus) and serves as host for peripheral controllers 804(1)-804(4). Network interface 832 provides access to a network (e.g., Internet, home network, etc.) and may be any of a wide variety of various wire or wireless interface components including an Ethernet card, a modem, a wireless access card, a Bluetooth module, a cable modem, and the like.

In the implementation depicted in FIG. 18 console 800 includes a controller support subassembly 840 for supporting four controllers 804(1)-804(4). The controller support subassembly 840 includes any hardware and software components needed to support wired and wireless operation with an external control device, such as for example, a media and game controller. A front panel I/O subassembly 842 supports the multiple functionalities of power button 812, the eject button 813, as well as any LEDs (light emitting diodes) or other indicators exposed on the outer surface of console 802. Subassemblies 840 and 842 are in communication with module 814 via one or more cable assemblies 844. In other implementations, console 800 can include additional controller subassemblies. The illustrated implementation also shows an optical I/O interface 835 that is configured to send and receive signals that can be communicated to module 814.

MUs 840(1) and 840(2) are illustrated as being connectable to MU ports “A” 830(1) and “B” 830(2) respectively. Additional MUs (e.g., MUs 840(3)-840(6)) are illustrated as being connectable to controllers 804(1) and 804(3), i.e., two MUs for each controller. Controllers 804(2) and 804(4) can also be configured to receive MUs (not shown). Each MU 840 offers additional storage on which games, game parameters, and other data may be stored. In some implementations, the other data can include any of a digital game component, an executable gaming application, an instruction set for expanding a gaming application, and a media file. When inserted into console 800 or a controller, MU 840 can be accessed by memory controller 802. A system power supply module 850 provides power to the components of gaming system 800. A fan 852 cools the circuitry within console 800. A microcontroller unit 854 is also provided.

An application 860 comprising machine instructions is stored on hard disk drive 808. When console 800 is powered on, various portions of application 860 are loaded into RAM 806, and/or caches 810 and 812, for execution on CPU 801, wherein application 860 is one such example. Various applications can be stored on hard disk drive 808 for execution on CPU 801.

Gaming and media system 800 may be operated as a standalone system by simply connecting the system to display 16, a television, a video projector, or other display device. In this standalone mode, gaming and media system 800 enables one or more players to play games, or enjoy digital media, e.g., by watching movies, or listening to music. However, with the integration of broadband connectivity made available through network interface 832, gaming and media system 800 may further be operated as a participant in a larger network gaming community.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A controller for a content presentation and interaction system including a primary content presentation device, comprising:
a tactile control input responsive to the inputs of a first user and communicatively coupled to the content presentation device, including a plurality of tactile input mechanisms and providing a first set of control inputs manipulating content;
a touch screen control input responsive to the inputs of the first user and communicatively coupled to the content presentation device, the screen proximate the tactile control input and providing a second set of control inputs, the second set of control inputs including alternative inputs for at least some of the first set of control inputs and additional inputs not available using the tactile input mechanisms.

2. The controller of claim 1 wherein the controller communicates with the content presentation device and the content presentation device communicates with an entertainment service via a network, the service providing one or more elements of a secondary interface, the secondary interface comprising one or more of:
an application help interface;
an application control interface;
an alternative game view interface;
an information interface providing additional information regarding the content.

3. The controller of claim 2 wherein the touch screen control input includes a processor and a connector, and the touch screen control input is connected to the tactile control input by the connector.

4. The controller of claim 3 wherein the first includes at least one imaging camera, the imaging camera in communication with the processing device to provide input for the secondary user interface.

5. The controller of claim 4 wherein at least a portion the first set of control inputs is provided in the second set.

6. An content presentation and interaction system, comprising:
a content output device presenting content for a user, the output device responsive to a plurality of control inputs;
a first controller responsive to the inputs of a first user and communicatively coupled to the first processing device, the first controller including a plurality of tactile input apparatus and providing a first set of the plurality of control inputs; and
a second, touch interface controller responsive to the inputs of the first user and communicatively coupled to the first processing device, second controller proximate the first controller and providing a second set of the plurality of control inputs from the first user and a secondary user interface.

7. The content presentation and interaction system of claim 6 wherein the content output device communicates with a content service via a network, the service providing one or more elements of a secondary interface.

8. The content presentation and interaction system of claim 6 wherein the second controller includes a processor and a connector, and the second controller is connected to the first controller.

9. The content presentation and interaction system of claim 6 wherein the second controller includes a processor and a wireless communication system, and the second controller is coupled to the output device via the wireless communication system.

10. The content presentation and interaction system of claim 6 wherein the output device communicates with an content service via a network, the service providing one or more elements of a secondary interface and wherein the second controller includes a processor and a wireless communication system, and the second controller is coupled to the content service via a network.

11. The content presentation and interaction system of claim 6 wherein at least a portion the first set of the plurality of control inputs is provided in the second set.

12. The content presentation and interaction system of claim 6 wherein the secondary interface comprises one or more of:
an application help interface;
an application control interface;
an alternative game view interface;
an information interface providing additional information regarding the content.

13. The content presentation and interaction system of claim 6 wherein the first processing device communicates with one or more third party content providers and an content presentation and interaction service, the first processing device outputs user information on third party content consumed by the user, and the processing device receives components of the secondary interface from the content presentation and interaction service.

14. The content presentation and interaction system of claim 6 wherein the first controller or the second controller includes at least one imaging camera, the imaging camera in communication with the processing device to provide input for the secondary user interface.

15. A content presentation and interaction system, comprising:
a first processing device executing a content presentation application, the content application responsive to a plurality of control inputs;
a tactile controller responsive to the inputs of a first user and communicatively coupled to the content output device, the tactile controller including a plurality of tactile input mechanisms and providing a first set of the plurality of control inputs manipulating the content;
a touch screen controller responsive to the inputs of the first user and communicatively coupled to the device, the touch screen controller proximate the tactile controller and providing a secondary input interface, the interface receiving a second set of the plurality of control inputs, the second set of the plurality of control inputs including alternative inputs for at least some of the first set of the plurality of inputs and additional inputs not available using the tactile input mechanisms.

16. The content presentation and interaction system of claim 15 wherein the first processing device communicates with an entertainment service via a network, the service providing one or more elements of the secondary interface based on content provided in the content output device.

17. The content presentation and interaction system of claim 16 wherein the touch screen controller and the tactile controller are integrated in a single housing.

18. The content presentation and interaction system of claim 17 wherein the first processing device communicates with an entertainment service via a network, the service providing one or more elements of a secondary interface and wherein the touch screen controller includes a processor and a wireless communication system, and the touch screen controller is coupled to the entertainment service via a network.

19. The content presentation and interaction system of claim 18 wherein at least a portion the first set of the plurality of control inputs is provided in the second set.

20. The content presentation and interaction system of claim 19 wherein the secondary interface comprises one or more of:
an application help interface;
an application control interface;
an alternative game view interface;
an information interface providing additional information regarding the content.
